(19) United States
(12) Patent Application Publication
(10) Pub. No.: US 2016/0004124 A1
(43) Pub. Date: Jan. 7, 2016

(54) HIGH COLOR GAMUT QUANTUM DOT DISPLAY

(71) Applicant: 3M INNOVATIVE PROPERTIES COMPANY, Saint Paul, MN (US)

(72) Inventors: Gilles J. BENOIT, Minneapolis, MN (US); John A. WHEATLEY, Lake Elmo, MN (US); James A. THIELEN, Hugo, MN (US)

(21) Appl. No.: 14/766,689

(22) PCT Filed: Jan. 28, 2014
(86) PCT No.: PCT/US2014/013338

§ 371 Date: Aug. 7, 2015

Related U.S. Application Data
(60) Provisional application No. 61/762,681, filed on Feb. 8, 2013.

(51) Int. Cl. G02F 1/1335

(52) U.S. Cl. CPC G02F 1/133603; G02F 2001/133614

(57) ABSTRACT

An optical construction is described that includes a blue light source, a liquid crystal display panel, and a quantum dot film element optically between the blue light source and the liquid crystal display panel. In some embodiments, the blue light source can emit blue light that has a wavelength in a range from 440 to 460 nm and an FWHM of less than 25 nm. Also, in some embodiments, the quantum dot film element includes a plurality of quantum dots emitting a peak red wavelength in a range from 600 to 640 nm, an FWHM of less than 50 nm, a peak green wavelength in a range from 515 to 555 nm, and an FWHM of less than 40 nm. The quantum dot film element can be optically between the blue light source and the LCD panel.

### FIELD

The disclosure relates to the design of LCD displays that deliver an improved color gamut area (measured as % NTSC) using a quantum dot element.

### BACKGROUND

Liquid crystal displays (LCDs) are non-emissive displays that utilize a separate backlight unit and red, green, and blue color filters for pixels to display a color image on a screen. The red, green, and blue color filters respectively separate white light emitted from the backlight unit into red, green, and blue lights. The red, green, and blue color filters each transmit only light of a narrow wavelength band and absorb the rest of the visible spectrum, resulting in significant optical loss. Thus, a high luminance backlight unit is needed to produce an image with sufficient luminance. The range of colors that can be displayed by an LCD device is called color gamut and is determined by the combined spectra of the backlight unit and the color filters of the LCD panel. Thicker, more absorbing color filters result in more saturated primaries and a broader range of color gamut (measured as % NTSC) as well as lower luminance

A panel's native color gamut can be referred to as the color gamut area that can be achieved in combination with a backlight unit containing white LEDs. Typical white LEDs consist of a blue LED die combined with a yellow YAG phosphor. Native color gamut typically ranges from 40% NTSC for some handheld devices to over 100% NTSC for specialty monitors. LCD panel constructions with improved color gamut or increased efficacy are desired.

### BRIEF SUMMARY

In a first aspect of the disclosure, an optical construction includes a blue light source emitting blue light having a wavelength in a range from 440 to 460 nm and an FWHM of less than 25 nm, a liquid crystal display (LCD) panel including a set of red, green and blue color filters, and a quantum dot film element positioned optically between the blue light source and the LCD panel. The quantum dot film element includes a plurality of quantum dots emitting a peak red wavelength in a range from 600 to 640 nm and an FWHM of less than 50 nm and a peak green wavelength in a range from 515 to 555 nm and an FWHM of less than 40 nm. Additional elements can also be present between the light source and the LCD panel to provide collimation and polarization recycling.

In one or more embodiments, the optical construction includes a blue LED light source emitting blue light having a wavelength in a range from 440 to 460 nm and an FWHM of less than 25 nm, an LCD panel having a native color gamut in a range from 35% to 45% NTSC, and a quantum dot film element positioned or optically between the blue light source and the LCD panel. The quantum dot film element includes a plurality of quantum dots emitting a peak red wavelength of in a range from 605 to 625 nm and an FWHM of less than 45 nm and a peak green wavelength in a range from 530 to 550 nm and an FWHM of less than 35 nm. The optical construction achieves a color gamut of at least 50% NTSC.

In one or more embodiments, the optical construction includes a blue LED light source emitting blue light having a wavelength in a range from 440 to 460 nm and an FWHM of less than 25 nm, an LCD panel having a native color gamut in a range from 45% to 55% NTSC, and a quantum dot film element optically or positioned between the blue light source and the LCD panel. The quantum dot film element includes a plurality of quantum dots emitting a peak red wavelength of in a range from 605 to 625 nm and an FWHM of less than 45 nm and a peak green wavelength in a range from 530 to 550 nm and an FWHM of less than 35 nm. The optical construction achieves a color gamut of at least 60% NTSC.

In one or more embodiments, the optical construction includes a blue LED light source emitting blue light having a wavelength in a range from 440 to 460 nm and an FWHM of less than 25 nm, an LCD panel having a native color gamut in a range from 55% to 65% NTSC, and a quantum dot film element optically or positioned between the blue light source and the LCD panel. The quantum dot film element includes a plurality of quantum dots emitting a peak red wavelength of in a range from 605 to 625 nm and an FWHM of less than 45 nm and a peak green wavelength in a range from 530 to 550 nm and an FWHM of less than 35 nm. The optical construction achieves a color gamut of at least 70% NTSC.

In one or more embodiments, the optical construction includes a blue LED light source emitting blue light having a wavelength in a range from 440 to 460 nm and an FWHM of less than 25 nm, an LCD panel having a native color gamut in a range from 55% to 65% NTSC, and a quantum dot film element optically or positioned between the blue light source and the LCD panel. The quantum dot film element includes a plurality of quantum dots emitting a peak red wavelength of in a range from 615 to 635 nm and an FWHM of less than 45 nm and a peak green wavelength in a range from 520 to 540 nm and an FWHM of less than 35 nm. The optical construction achieves a color gamut of at least 80% NTSC.

In one or more embodiments, the optical construction includes a blue LED light source emitting blue light having a wavelength in a range from 440 to 460 nm and an FWHM of less than 25 nm, an LCD panel having a native color gamut in a range from 65% to 75% NTSC, and a quantum dot film element optically or positioned between the blue light source and the LCD panel. The quantum dot film element includes a plurality of quantum dots emitting a peak red wavelength of in a range from 610 to 630 nm and an FWHM of less than 45 nm and a peak green wavelength in a range from 520 to 540 nm and an FWHM of less than 35 nm. The optical construction achieves a color gamut of at least 80% NTSC.

In one or more embodiments, the optical construction includes a blue LED light source emitting blue light having a wavelength in a range from 440 to 460 nm and an FWHM of less than 25 nm, an LCD panel having a native color gamut in a range from 75% to 85% NTSC, and a quantum dot film element optically or positioned between the blue light source and the LCD panel. The quantum dot film element includes a plurality of quantum dots emitting a peak red wavelength of in a range from 610 to 630 nm and an FWHM of less than 45 nm and a peak green wavelength in a range from 525 to 540 nm and an FWHM of less than 35 nm. The optical construction achieves a color gamut of at least 90% NTSC.

In one or more embodiments, the optical construction includes a blue LED light source emitting blue light having a wavelength in a range from 440 to 460 nm and an FWHM of less than 25 nm, an LCD panel having a native color gamut in a range from 85% to 95% NTSC, and a quantum dot film element optically or positioned between the blue light source and the LCD panel. The quantum dot film element includes a plurality of quantum dots emitting a peak red wavelength of in a range from 610 to 630 nm and an FWHM of less than 45 nm and a peak green wavelength in a range from 520 to 540 nm and an FWHM of less than 35 nm. The optical construction achieves a color gamut of at least 100% NTSC.

In a second aspect of the disclosure, a method includes choosing a target color gamut for an optical display, assembling the optical display and selecting a quantum dot element peak red wavelength and red FWHM and the peak green wavelength and green FWHM to achieve the target color gamut for the optical display. The optical display includes a blue light source, an LCD panel comprising a set of red, blue and green color filters and having a native color gamut being less than the target color gamut by at least 10%, a quantum dot film element comprising a plurality of quantum dots emitting a peak red wavelength having a red FWHM and a peak green wavelength having a green FWHM and being optically between the blue light source and the LCD panel.

In one or more embodiments the selecting step comprises selecting the peak red wavelength in a range from 600 to 640 nm and having an FWHM of less than 50 nm and the peak green wavelength in a range from 515 to 555 nm and having an FWHM of less than 40 nm.

In one or more embodiments the selecting step comprises selecting the peak red wavelength in a range from 600 to 640 nm and having an FWHM of less than 45 nm and the peak green wavelength in a range from 515 to 555 nm and having an FWHM of less than 35 nm.

In one or more embodiments the selecting step comprises selecting the peak red wavelength in a range from 605 to 635 nm and having an FWHM of less than 45 nm and the peak green wavelength in a range from 520 to 550 nm and having an FWHM of less than 35 nm.

In one or more embodiments the blue light source has a wavelength in a range from 440 to 460 nm and an FWHM of less than 25 nm or less than 20 nm.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic side elevation view of an illustrative optical construction;

FIG. 2A and 2B are graphs showing a side-by-side comparison of the normalized Spectral Power Density (SPD) of a white LED backlight (FIG. 2a) and a Quantum Dot (QD) backlight (FIG. 2b);

FIG. 3 is a graph comparing the standard 1953 NTSC color space (100% NTSC) to the color spaces achieved with a Quantum Dot backlight unit (72.5% NTSC) and a white LED backlight unit (60.5% NTSC) when combined with an LCD panel of native color gamut equal to 60% NTSC;

FIG. 4 is a bar chart of system color gamut of the quantum dot optical construction next to native color gamut of white LED optical construction;

FIG. 5 is a bar chart of total system efficacy of white LED optical constructions next to quantum dot optical constructions at 40%, 50%, 60%, 70%, 80% and 90% NTSC native color gamut;

FIG. 6 is a graph of color gamut versus system efficacy of LED optical constructions and quantum dot optical constructions.

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.”

Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

The term “light recycling element” refers to an optical element that recycles or reflects a portion of incident light and transmits a portion of incident light. Illustrative light recycling elements include reflective polarizers, micro-structured films, metallic layers, multi-layer optical film and combinations thereof.

The term “% NTSC” refers to the quantification of color gamut. NTSC stands for the National Television System Committee. In 1953 NTSC defined a color television standard colorimetry with the following CIE color coordinates:

| | | |
|---|---|---|
| primary red | 0.67 | 0.33 |
| primary green | 0.21 | 0.71 |
| primary blue | 0.14 | 0.08 |
| white point (CIE Standard illuminant C) | 0.310 | 0.316 |

The (color) gamut of a device or process is the portion of the CIE color space that can be reproduced. To quantify the color gamut of an LCD display, the area of the triangle defined by its three primaries (i.e., red, green, blue color filters on) is normalized to the area of the standard NTSC triangle and reported as % NTSC.

The phrase “native color gamut” refers to the color gamut area that can be achieved in combination with a backlight unit containing white LEDs.

The term “FWHM” stands for Full Width at Half Maximum. As the name indicates, it is given by the distance between points on the curve at which the function reaches half its maximum value and is approximately symmetric about its maximum value.

The disclosure relates to the design of LCD displays that deliver a target color gamut area (measured as % NTSC) using an LCD panel of lower native color gamut by at least 10% combined with a backlight unit containing blue LEDs and green and red quantum dots, resulting in much improved system luminance, among other aspects. The use of blue LEDs and green and red quantum dots in a backlight to generate a white spectrum with narrow blue, green and red emission peaks can deliver a better trade-off between color gamut and luminance than traditional devices that utilize white LEDs. In fact, when using a quantum dot backlight, a target color gamut can be achieved using an LCD panel whose native color gamut is at least 10% lower, resulting in higher luminance output and/or lower power consumption. While the present disclosure is not so limited, an appreciation of various aspects of the disclosure will be gained through a discussion of the examples provided below.

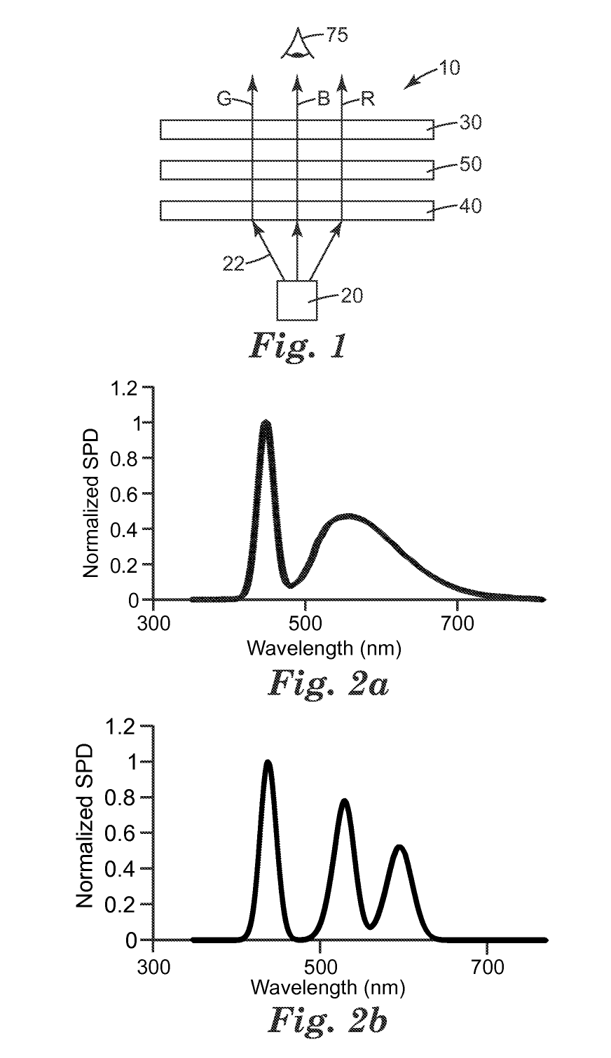

FIG. 1 is a schematic cross-sectional view of an illustrative optical construction 10. The optical construction 10 includes a blue light source 20 emitting blue light 22, and a liquid crystal display panel 30 having a set of red, blue and green color filters and having a native color gamut being less than the target color gamut by at least 10%. The construction 10 also includes a quantum dot film element 40 including a plurality of quantum dots emitting a peak red wavelength having a red FWHM and a peak green wavelength having a green FWHM and being optically between the blue light source 20 and the liquid crystal display panel 30. A viewer 75 faces a viewing or display side of the optical construction 10 and can discern the green light G, red light R and blue light B emitted from the optical construction 10. An optional light recycling element 50 can be optically between the quantum dot film element 40 and the liquid crystal display panel 30.

In one or more embodiments, the blue light source 20 and the quantum dot film element 40 can be integrated into a single element such as a backlight forming a quantum dot backlight, for example. In one embodiment, the quantum dot film element 40 can be incorporated into a diffuser film of the backlight or replace the diffuser film of a backlight. Thus the quantum dot backlight can be a “drop-in” backlight solution to any display or LCD display.

The blue light source 20 emitting blue light 22 can be any useful blue light source. In one or more embodiments the blue light source 20 is a solid state element such as a light emitting diode, for example.

In one or more embodiments the blue light source 20 emits blue light 22 at a wavelength in a range from 440 to 460 nm and an FWHM of less than 25 rim or less than 20 nm.

The quantum dot film element refers to a layer or film of resin or polymer material that includes a plurality of quantum dots or quantum dot material. In many embodiments, this material is sandwiched between two barrier films. Suitable barrier films include plastic, glass or dielectric materials, for example.

The quantum dot film element can include one or more populations of quantum dot material. Exemplary quantum dots or quantum dot material emit green light and red light upon down-conversion of blue primary light from the blue LED to secondary light emitted by the quantum dots. The respective portions of red, green, and blue light can be controlled to achieve a desired white point for the white light emitted by the display device incorporating the quantum dot film element.

Exemplary quantum dots for use in integrated quantum dot constructions described herein include CdSe or ZnS. Suitable quantum dots for use in integrated quantum dot constructions described herein include core/shell luminescent nanocrystals including CdSe/ZnS, InP/ZnS, PbSe/PbS, CdSe/CdS, CdTe/CdS or CdTe/ZnS. In exemplary embodiments, the luminescent nanocrystals include an outer ligand coating and are dispersed in a polymeric matrix. Quantum dot and quantum dot material are commercially available from Nanosys Inc., Palo Alto, Calif.). In many embodiments, the refractive index of the quantum dot film element is in a range from 1.4 to 1.6, or from 1.45 to 1.55.

It has been discovered that the selection of specific red and green emitting quantum dot populations having a specified peak emission and FWHM forming the quantum dot material can improve the color gamut of a liquid crystal display panel. In one or more embodiments, the optical construction can specify a target color gamut and an LCD panel having a native color gamut being less than the target color gamut by at least 10% or at least 15% or at least 20% can be utilized with specifically chosen red and green emitting quantum dot populations having a specified peak emission and FWHM forming the quantum dot material to achieve the target color gamut.

In one or more embodiments, the quantum dot film element includes a plurality of quantum dots emitting a peak red wavelength in a range from 600 to 640 nm and an FWHM of less than 50 nm and a peak green wavelength in a range from 515 to 555 nm and an FWHM of less than 40 nm.

In one or more embodiments, the LCD panel has a native color gamut in a range from 35% to 45% NTSC, and the quantum dot film element includes a plurality of quantum dots emitting a peak red wavelength of in a range from 605 to 625 nm and an FWHM of less than 45 nm and a peak green wavelength in a range from 530 to 550 nm and an FWHM of less than 35 nm. The optical construction then achieves a color gamut of at least 50% NTSC.

In one or more embodiments, the LCD panel has a native color gamut in a range from 45% to 55% NTSC, and the quantum dot film element includes a plurality of quantum dots emitting a peak red wavelength of in a range from 605 to 625 nm and an FWHM of less than 45 nm and a peak green wavelength in a range from 530 to 550 nm and an FWHM of less than 35 nm. The optical construction then achieves a color gamut of at least 60% NTSC.

In one or more embodiments, the LCD panel has a native color gamut in a range from 55% to 65% NTSC, and the quantum dot film element includes a plurality of quantum dots emitting a peak red wavelength of in a range from 605 to 625 nm and an FWHM of less than 45 nm and a peak green wavelength in a range from 530 to 550 nm and an FWHM of less than 35 nm. The optical construction then achieves a color gamut of at least 70% NTSC.

In one or more embodiments, the LCD panel has a native color gamut in a range from 55% to 65% NTSC, and the quantum dot film element includes a plurality of quantum dots emitting a peak red wavelength of in a range from 615 to 635 nm and an FWHM of less than 45 nm and a peak green wavelength in a range from 525 to 540 nm and an FWHM of less than 35 nm. The optical construction then achieves a color gamut of at least 80% NTSC.

In one or more embodiments, the LCD panel has a native color gamut in a range from 65% to 75% NTSC, and the quantum dot film element includes a plurality of quantum dots emitting a peak red wavelength of in a range from 610 to 630 nm and an FWHM of less than 45 nm and a peak green wavelength in a range from 520 to 540 nm and an FWHM of less than 35 nm. The optical construction then achieves a color gamut of at least 80% NTSC.

In one or more embodiments, the LCD panel has a native color gamut in a range from 75% to 85% NTSC, and the quantum dot film element includes a plurality of quantum dots emitting a peak red wavelength of in a range from 610 to 630 nm and an FWHM of less than 45 nm and a peak green wavelength in a range from 520 to 540 nm and an FWHM of less than 35 nm. The optical construction then achieves a color gamut of at least 90% NTSC.

In one or more embodiments, the LCD panel has a native color gamut in a range from 85% to 95% NTSC, and the quantum dot film element includes a plurality of quantum dots emitting a peak red wavelength of in a range from 610 to 630 nm and an FWHM of less than 45 nm and a peak green wavelength in a range from 525 to 540 nm and an FWHM of less than 35 nm. The optical construction then achieves a color gamut of at least 100% NTSC.

Illustrative light recycling elements include reflective polarizers, micro-structured films, metallic layers, multi-layer optical film and combinations thereof. Micro-structured films include brightness enhancing films. The multilayer optical film can selectively reflect one polarization of light (e.g., a reflective polarizer described herein) or can be none selective with respect to polarization. In many examples the light recycling element reflects or recycles at least 50% of incident light, or at least 40% or incident light or at least 30% of incident light. In some embodiments the light recycling element includes a metallic layer.

The reflective polarizer can be any useful reflective polarizer element. A reflective polarizer transmits light with a single polarization state and reflects the remaining light. Illustrative reflective polarizers include birefringent reflective polarizers, fiber polarizers and collimating multilayer reflectors. A birefringent reflective polarizer includes a multilayer optical film having a first layer of a first material disposed (e.g., by coextrusion) on a second layer of a second material. One or both of the first and second materials may be birefringent. The total number of layers may be tens, hundreds, thousands or more. In some exemplary embodiments, adjacent first and second layers may be referred to as an optical repeating unit. Reflective polarizers suitable for use in exemplary embodiments of the present disclosure are described in, e.g., U.S. Pat. Nos. 5,882,774, 6,498,683, 5,808,794, which are incorporated herein by reference. Any suitable type of reflective polarizer may be used for the reflective polarizer, e.g., multilayer optical film (MOF) reflective polarizers; diffusely reflective polarizing film (DRPF), such as continuous/disperse phase polarizers; wire grid reflective polarizers; or cholesteric reflective polarizers. Brightness enhancing films generally enhance on-axis luminance (referred herein as “brightness”) of a lighting device. Brightness enhancing films can be light transmissible, microstructured films. The If microstructured topography can be a plurality of prisms on the film surface such that the films can be used to redirect light through reflection and refraction. The height of the prisms can range from about 1 to about 75 micrometers. When used in an optical construction or display such as that found in laptop computers, watches, etc., this microstructured optical film can increase brightness of an optical construction or display by limiting light escaping from the display to within a pair of planes disposed at desired angles from a normal axis running through the optical display. As a result, light that would exit the display outside of the allowable range is reflected back into the display where a portion of it can be “recycled” and returned back to the microstructured film at an angle that allows it to escape from the display. The recycling is useful because it can reduce power consumption needed to provide a display with a desired level of brightness.

Brightness enhancing films include microstructure-bearing articles having a regular repeating pattern of symmetrical tips and grooves. Other examples of groove patterns include patterns in which the tips and grooves are not symmetrical and in which the size, orientation, or distance between the tips and grooves is not uniform. Examples of brightness enhancing films are described in Lu et al., U.S. Pat. No. 5,175,030, and Lu, U.S. Pat. No. 5,183,597, incorporated herein by reference.

Some of the advantages of the disclosed quantum dot optical constructions are further illustrated by the following examples. The particular materials, amounts and dimensions recited in this example, as well as other conditions and details, should not be construed to unduly limit the present disclosure.

### EXAMPLES

### Example

The color gamut and efficacy performance of LCD displays utilizing a white LED backlight and a quantum dot backlight were compared.

A quantum dot display was modeled as follows. Using the MATLAB software package (available from MathWorks, Natick Mass.), a computer model of the display system was prepared. The system's primary light source was a blue LED. The blue LED illuminated a quantum dot film consisting of red- and green-emitting quantum dots. The LED and quantum dots were characterized by their intrinsic full-width-at-half-maximum (FWHM). For the blue LED, FHWM was 20 nm. For the green and red quantum dots, the FWHM values were 33 nm and 40 nm respectively. The emission wavelengths of the LED and quantum dots were selected to maximize the displayed color gamut. That selection process was also constrained to closely approximate or augment an appropriate standard color space (HDTV sRGB color space with 72% NTSC color gamut: x_{b}=0.15, y_{b}=0.06, x_{g}=0.3, y_{g}=0.6, xᵣ=0.64, yᵣ=0.33 or Adobe RGB color space with 98% NTSC color gamut: x_{b}=0.15, y_{b}=0.06, x_{g}=0.21, y_{g}=0.71, xᵣ=0.64, yᵣ=0.33).

The relative proportion of red and green quantum dots was then tuned to deliver a target white point (HDTV sRGB standard: x_{w}=0.313, y_{w}=0.329, Adobe RGB standard: x_{w}=0.31, y_{w}=0.33). The model also included two BEF (brightness enhancement films) positioned above the quantum dot film. One BEF film had prisms running along a horizontal axis and the second had prisms running perpendicularly along the vertical axis. The BEF films were modeled as isosceles prism films with 24 micron pitch. Then, above the crossed BEF films, the model included a standard LCD panel with native color gamut of 40% NTSC, 50% NTSC, 60% NTSC, 70% NTSC, 80% NTSC or 90% NTSC. The white LED display was modeled in a similar fashion. The only variable that was adjusted was the ratio of blue light from the LED die to yellow light from the YAG phosphor to match the white point of the quantum dot display.

FIG. 2A and 2B illustrate the shape of the spectral power density of a white LED backlight (FIG. 2a) and a Quantum Dot (QD) backlight (FIG. 2b) modeled as previously described.

Efficacy was computed as follows. First, the output spectrum of the display was determined by the combined spectra of the blue LEDs and quantum dot film (after recycling in the backlight unit including absorption losses, Stokes losses and quantum efficiency losses), modified (i.e., multiplied point by point) by the spectrum of the color filters and by the photopic luminosity function that represents color sensitivity of the human eye. Then the resulting spectrum was integrated across the range of visible wavelengths (400 to 750 nm) to produce a combined output luminous flux (in lumens). Next, just the spectrum of the blue LED (before down-conversion) was integrated, also across the range of visible wavelengths, to determine the blue LED optical power (in Watts). The ratio of the combined luminous flux to the blue LED optical power was computed as optical efficacy (in lumens/Watt). This ratio was then multiplied by the electrical efficiency of the blue LED (assumed to be 46%). The resulting quantity provided a measure of efficacy in lumens per plug-watt. The efficacy of the reference white LED was ˜110 lm/W.

Color gamut was calculated as the ratio of the area of the color space of the display (defined by the primaries CIE coordinates x_{b}, y_{b}, x_{g}, y_{g}, xᵣ, yᵣ) to the area of the 1953 color NTSC triangle. The CIE color coordinates of each blue, green and red primaries were calculated using the combined spectra of the backlight unit and the corresponding color filter.

FIG. 3 illustrates the color spaces that can be achieved with an LCD panel of native color gamut equal to 60% NTSC when combined with a white LED backlight unit and a quantum dot backlight unit. The standard 1953 NTSC triangle is also shown for reference. As expected the white LED backlight delivers a color space equal to 60.5% NTSC. The quantum dot backlight delivers a larger color space equal to 72.5% NTSC. The spectra of the white LED backlight and the quantum dot backlight are the ones shown in FIGS. 2a-b.

Following this method, the color gamut and efficacy of displays consisting of an LCD panel of native color gamut 40% NTSC, 50% NTSC, 60% NTSC, 70% NTSC, 80% NTSC, and 90% NTSC were calculated for a white LED backlight and a quantum dot containing backlight construction.

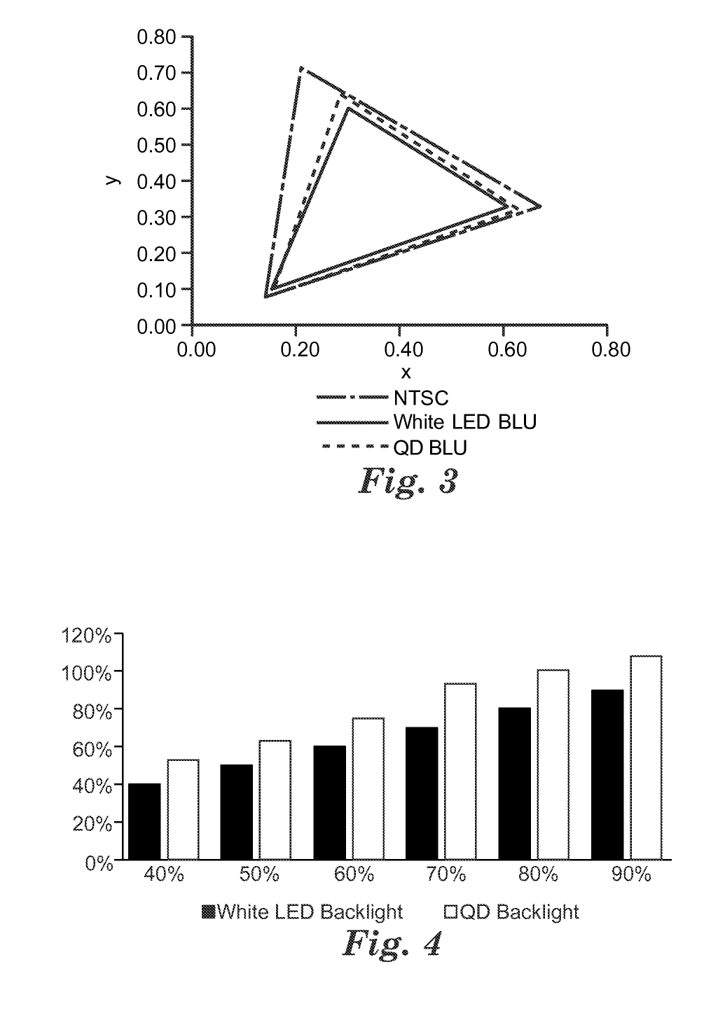

FIG. 4 is a graph of system color gamut of the quantum dot (QD) optical construction next to native color gamut of white LED optical construction. This graph represents the color gamut (calculated as % NTSC) achieved with an LCD panel of native color gamut equal to 40%, 50%, 60%, 70%, 80%, and 90% (x axis) with a white LED backlight (black bars) and a QD backlight (white bars). When using a QD backlight, the achieved color gamut is at least 10% NTSC higher than the native color gamut (achieved with a white LED backlight). On average, the increase is equal to 17% NTSC.

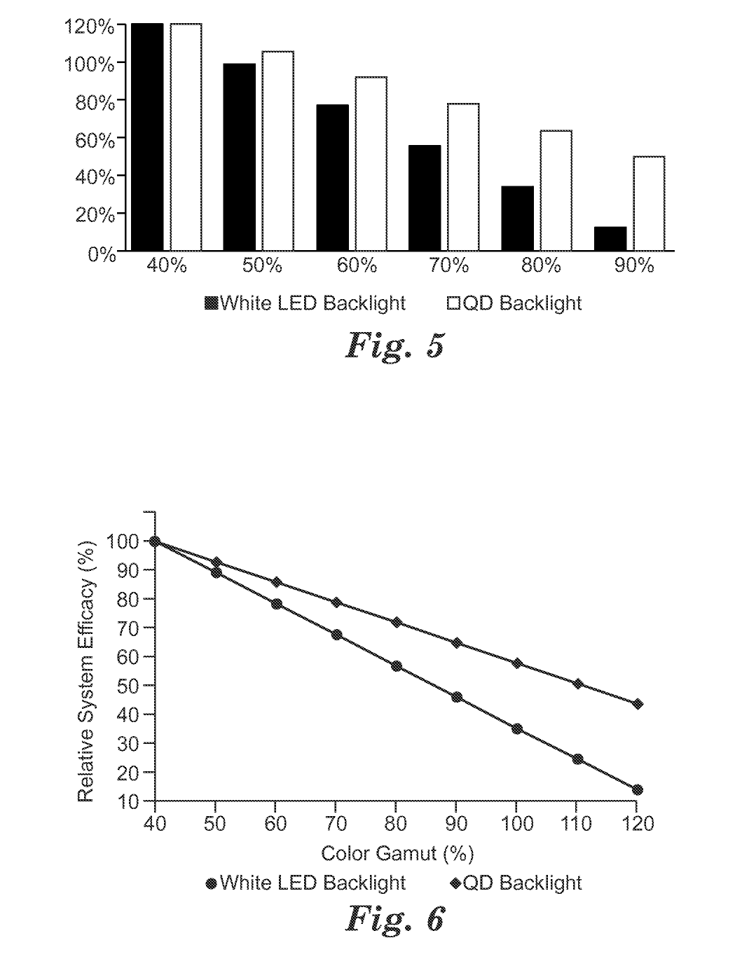

FIG. 5 is a graph of total system efficacy of white LED optical constructions next to quantum dot optical constructions at 40%, 50%, 60%, 70%, 80% and 90% NTSC native color gamut.

This graph represents total system efficacy (calculated in lumen/W and normalized) achieved with an LCD panel of native color gamut equal to 40%, 50%, 60%, 70%, 80%, and 90% (x axis) combined with a white LED backlight (black bars) and a QD backlight (white bars). The reference white LED is assumed to have an efficacy of 110 lumen/W. When using a QD backlight, system efficacy is higher than with a white LED backlight for color gamut targets above 40% NTSC. This is due to the fact that in order to deliver a target color gamut, a QD backlight with narrow emission peaks can be combined with a panel of native color gamut at least 10% NTSC lower than target, resulting in higher transmission and therefore higher system efficacy.

FIG. 6 is a graph of color gamut versus system efficacy of LED optical constructions and quantum dot optical constructions. This graph represents the relationship between color gamut and system efficacy for a white LED backlight+LCD panel display versus a QD backlight+LCD panel display. The reference white LED is assumed to have an efficacy of ˜110 lm/W. The slope of the QD system is higher than that of the white LED system indicating that a QD backlight is the preferred solution for high color gamut displays.

1. An optical construction comprising:
a blue light source emitting blue light having a wavelength in a range from 440 to 460 nm and an FWHM of less than 25 nm;
a liquid crystal display (LCD) panel comprising a set of red, blue and green color filters; and
a quantum dot film element comprising a plurality of quantum dots emitting a peak red wavelength in a range from 600 to 640 nm and an FWHM of less than 50 nm and a peak green wavelength in a range from 515 to 555 nm and an FWHM of less than 40 nm and being optically between the blue light source and the LCD panel.

2. The optical construction of claim 1, wherein:
the blue LED light source emits blue light having a wavelength in a range from 440 to 460 nm and an FWHM of less than 25 nm;
the LCD panel has a native color gamut in a range from 35% to 45% NTSC;
the quantum dot film element comprises a plurality of quantum dots emitting a peak red wavelength of in a range from 605 to 625 nm and an FWHM of less than 45 nm and a peak green wavelength in a range from 530 to 555 nm and an FWHM of less than 35 nm and being optically between the blue light source and the LCD panel;
the optical construction achieves a color gamut of at least 50% NTSC.

3. The optical construction of claim 1, wherein:
the blue LED light source emits blue light having a wavelength in a range from 440 to 460 nm and an FWHM of less than 25 nm;
the LCD panel has a native color gamut in a range from 45% to 55% NTSC;
the quantum dot film element comprises a plurality of quantum dots emitting a peak red wavelength of in a range from 605 to 625 nm and an FWHM of less than 45 nm and a peak green wavelength in a range from 530 to 550 nm and an FWHM of less than 35 nm and being optically between the blue light source and the LCD panel; and
the optical construction achieves a color gamut of at least 60% NTSC.

4. The optical construction of claim 1, wherein:
the blue LED light source emits blue light having a wavelength in a range from 440 to 460 nm and an FWHM of less than 25 nm;
the LCD panel has a native color gamut in a range from 55% to 65% NTSC;
the quantum dot film element comprises a plurality of quantum dots emitting a peak red wavelength of in a range from 605 to 625 nm and an FWHM of less than 45 nm and a peak green wavelength in a range from 530 to 550 nm and an FWHM of less than 35 nm and being optically between the blue light source and the LCD panel;
the optical construction achieves a color gamut of at least 70% NTSC.

5. The optical construction of claim 1, wherein:
the blue LED light source emits blue light having a wavelength in a range from 440 to 460 nm and an FWHM of less than 25 nm;
the LCD panel has a native color gamut in a range from 55% to 65% NTSC;
the quantum dot film element comprises a plurality of quantum dots emitting a peak red wavelength of in a range from 615 to 635 nm and an FWHM of less than 45 nm and a peak green wavelength in a range from 520 to 540 nm and an FWHM of less than 35 nm and being optically between the blue light source and the LCD panel; and
the optical construction achieves a color gamut of at least 80% NTSC.

6. The optical construction of claim 1, wherein:
the blue LED light source emits blue light having a wavelength in a range from 440 to 460 nm and an FWHM of less than 25 nm;
the LCD panel has a native color gamut in a range from 65% to 75% NTSC;
the quantum dot film element comprises a plurality of quantum dots emitting a peak red wavelength of in a range from 610 to 630 nm and an FWHM of less than 45 nm and a peak green wavelength in a range from 520 to 540 nm and an FWHM of less than 35 nm and being optically between the blue light source and the LCD panel;
the optical construction achieves a color gamut of at least 80% NTSC.

7. The optical construction of claim 1, wherein:
the blue LED light source emits blue light having a wavelength in a range from 440 to 460 nm and an FWHM of less than 25 nm;
the LCD panel has a native color gamut in a range from 75% to 85% NTSC;
the quantum dot film element comprises a plurality of quantum dots emitting a peak red wavelength of in a range from 610 to 630 nm and an FWHM of less than 45 nm and a peak green wavelength in a range from 520 to 540 nm and an FWHM of less than 35 nm and being optically between the blue light source and the LCD panel; and
the optical construction achieves a color gamut of at least 90% NTSC.

8. The optical construction of claim 1, wherein:
the blue LED light source emits blue light having a wavelength in a range from 440 to 460 nm and an FWHM of less than 25 nm;
the LCD panel has a native color gamut in a range from 85% to 95% NTSC;
the quantum dot film element comprises a plurality of quantum dots emitting a peak red wavelength of in a range from 610 to 630 nm and an FWHM of less than 45 nm and a peak green wavelength in a range from 520 to 540 nm and an FWHM of less than 35 nm and being optically between the blue light source and the LCD panel; and
the optical construction achieves a color gamut of at least 100% NTSC.

9. The optical construction according to claim 1, further comprising a light recycling element optically between the quantum dot film element and the LCD panel.

10. A method comprising:
choosing a target color gamut for an optical display; and
assembling the optical display comprising:
a blue light source;
an LCD panel comprising a set of red, blue and green color filters and having a native color gamut being less than the target color gamut by at least 10%; and
a quantum dot film element comprising a plurality of quantum dots emitting a peak red wavelength having a red FWHM and a peak green wavelength having a green FWHM and being optically between the blue light source and the LCD panel; and
selecting the peak red wavelength and red FWHM and the peak green wavelength and green FWHM to achieve the target color gamut for the optical display.

11. The method according to claim 10, wherein selecting the peak red wavelength comprises selecting the peak red wavelength in a range from 600 to 640 nm and having an FWHM of less than 50 nm and the peak green wavelength in a range from 515 to 555 nm and having an FWHM of less than 40 nm.

12. The method according to claim 10, wherein selecting the peak red wavelength comprises selecting the peak red wavelength in a range from 600 to 640 nm and having an FWHM of less than 45 nm and the peak green wavelength in a range from 515 to 555 nm and having an FWHM of less than 35 nm.

13. The method according to claim 10, wherein selecting the peak red wavelength comprises selecting the peak red wavelength in a range from 605 to 635 nm and having an FWHM of less than 45 nm and the peak green wavelength in a range from 520 to 550 nm and having an FWHM of less than 35 nm.

14. The method according to claim 10, wherein the blue light source has a wavelength in a range from 440 to 460 nm and an FWHM of less than 25 nm.

15. The method according to claim 14, wherein the blue light source has a wavelength in a range from 440 to 460 nm and an FWHM of less than 20 nm.

16. The method according to claim 10, wherein assembling the optical display further comprises one or more light recycling elements between the quantum dot film element and the LCD panel.
